(19) United States
(12) Patent Application Publication
(10) Pub. No.: US 2025/0314782 A1
(43) Pub. Date: Oct. 9, 2025

(54) METHOD AND DEVICE FOR MEASURING POSITION OF VEHICLE

(71) Applicant: HL Klemove Corp., Incheon (KR)

(72) Inventor: Soon Woong KWON, Incheon (KR)

(73) Assignee: HL Klemove Corp., Incheon (KR)

(21) Appl. No.: 18/816,964

(22) Filed: Aug. 27, 2024

(30) Foreign Application Priority Data
Apr. 4, 2024 (KR) 10-2024-0045657

(51) Int. Cl. G01S 19/23; G01S 19/22

(52) U.S. Cl. CPC G01S 19/23; G01S 19/22

(57) ABSTRACT

The disclosure relates to a technology for measuring the position of a vehicle and provides a positioning device and method, comprising obtaining global positioning system (GPS) position information about a vehicle from a GPS satellite, generating a grid map including a first grid reflecting the GPS position information and calculating a position score associated with a possibility that the vehicle is to be positioned for each grid of the grid map based on sensing information, and searching for a second grid having a highest position score and correcting a positioning value of the vehicle based on a position convergence determination result of the second grid.

### CROSS-REFERENCE TO RELATED APPLICATION

This application claims priority from Korean Patent Application No. 10-2024-0045657, filed on Apr. 4, 2024, which is hereby incorporated by reference for all purposes as if fully set forth herein.

### BACKGROUND

### Field

The disclosure relates to a technology for measuring the position of a vehicle.

### Description of Related Art

In vehicle control, the position of the vehicle is an essential element. Depending on whether the position of the vehicle is accurately measured, the determination of the driving direction of the vehicle and the moving path to the destination may vary.

Conventionally, the position of a vehicle is measured based on information received from a global positioning system (GPS) satellite.

GPS refers to a satellite navigation system including at least 24 satellites. GPS satellites orbit around the Earth through set trajectories. Each GPS satellite may transmit and receive signals to and from a terminal or a ground station located on the ground.

The position of the vehicle may be measured based on the arrival time of the signal transmitted toward the GPS satellite vehicle. However, as the signals transmitted from the GPS satellites to measure the position of the vehicle are reflected by buildings, multipath occurs on a road dense with high-rise buildings, leading to misjudgment of a position different from the actual position of the position as the position of the vehicle, with the result of an error between the actual position of the vehicle and the GPS position information about the vehicle received from the GPS satellite.

In some cases, as the distance error is significant, and the vehicle is erroneously determined as driving in a lane other than the driving lane, the vehicle may be inaccurately controlled.

### BRIEF SUMMARY

The disclosure provides a technology for measuring the position of a vehicle.

In an aspect, the present embodiments provide a positioning device for measuring a position of a vehicle, comprising an information obtainer obtaining global positioning system (GPS) position information about a vehicle from a GPS satellite, a position score calculator generating a grid map including a first grid reflecting the GPS position information and calculating a position score associated with a possibility that the vehicle is to be positioned for each grid of the grid map based on sensing information, and a position determiner searching for a second grid having a highest position score and correcting a positioning value of the vehicle based on a position convergence determination result of the second grid.

In another aspect, the present embodiments provide a positioning method for measuring a position of a vehicle by a positioning device, comprising obtaining global positioning system (GPS) position information about a vehicle from a GPS satellite, calculating a position score for generating a grid map including a first grid reflecting the GPS position information and calculating the position score associated with a possibility that the vehicle is to be positioned for each grid of the grid map based on sensing information, and determining a position for searching for a second grid having a highest position score and correcting a positioning value of the vehicle based on a position convergence determination result of the second grid.

The disclosure may provide a technology for measuring the position of a vehicle.

### DESCRIPTION OF DRAWINGS

The above and other objects, features, and advantages of the disclosure will be more clearly understood from the following detailed description, taken in conjunction with the accompanying drawings, in which:

FIG. 1 is a view illustrating a configuration of a positioning device for correcting a positioning value of a vehicle, according to an embodiment;

FIG. 2 is a view illustrating a problem of a related art in which GPS position information about a vehicle received from a GPS satellite is unreliable;

FIG. 3 is a view illustrating a method for measuring the position of a vehicle, by a positioning device, based on a position score of a grid, according to an embodiment;

FIG. 4 is a flowchart illustrating a process of measuring the position of a vehicle, by a positioning device, based on a position score of a grid, according to an embodiment;

FIG. 5 is a flowchart illustrating a process of measuring the position of a vehicle, by a positioning device, according to an embodiment; and

FIG. 6 is a view illustrating a positioning method for correcting a positioning value of a vehicle, by a positioning device, according to an embodiment.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, embodiments are described in detail with reference to the accompanying drawings.

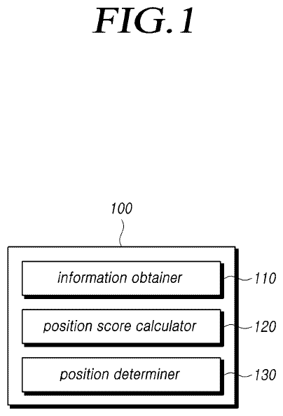

FIG. 1 is a view illustrating a configuration of a positioning device for correcting a positioning value of a vehicle, according to an embodiment.

Referring to FIG. 1, a positioning device 100 for measuring the position of a vehicle may include an information obtainer 110 for obtaining GPS position information about the vehicle from a global positioning system (GPS) satellite.

For example, the information obtainer 110 may further obtain high-precision map information and sensing information including position information about an object around the vehicle.

An object according to the disclosure is to correct GPS position information about a vehicle, assuming that the GPS position information about the vehicle received from the GPS satellite may be inaccurate. The correction of the GPS position information about the vehicle may be performed based on the sensing information detected by a sensing means provided in the vehicle and the position information about the object displayed on the high-definition map (HD map). The object may include a static object and a dynamic object.

The positioning device according to the disclosure may determine a position where a vehicle is most likely to be positioned through sensing information, position information about an object around the vehicle obtained from a high-precision map, and a grid searching scheme.

The positioning device 100 for measuring the position of the vehicle may include a position score calculator 120 for generating a grid map including a first grid reflecting GPS position information, and calculating a position score associated with a possibility that the vehicle is positioned for each grid of the grid map based on the sensing information. For example, the direction and distance from the sensing means to the object around the vehicle may be measured and displayed on the grid map, and the possibility that the vehicle is positioned for each grid may be quantified based on the information displayed on the grid map.

The grid map is a virtual map including one or more grids, and may have various shapes, such as a square, a rectangle, a triangle, and a circle, if necessary.

For example, the position score calculator 120 may generate the grid map centered on the first grid. The first grid may be a grid reflecting the position information received from the GPS satellite, and the grid map according to the disclosure may have a form in which other grids surround the first grid. The grid surrounding the first grid may form one layer. However, the disclosure is not limited thereto, and it may be a grid map composed of more layers as necessary.

As another example, the position score calculator 120 may regenerate a grid map, centered on the second grid and recalculate the position score for each grid included in the grid map, based on the position convergence determination result of the second grid not being position convergence. The second grid refers to the grid having the highest network score among all of the grids included in the grid map centered on the first grid.

The positioning device 100 may determine whether the second grid may be finally determined as the position of the vehicle according to a set criterion. In the disclosure, this may be referred to as position convergence determination. If the positioning device 100 determines that the second grid does not converge to the position of the vehicle, the position score calculator 120 included in the positioning device 100 may regenerate the grid map centered on the second grid and recalculate the position score of each grid included in the grid map. Regeneration of the grid map and recalculation of the position score of each grid are not limited to being performed one time, and if it is determined that the position convergence determination result is not position convergence, they may be repeatedly performed two or more times.

As another example, the position score calculator 120 may calculate the position score for each grid based on a grid searching algorithm that sequentially calculates the position score for each grid included in the grid map. The position score for each grid may be calculated based on sensing information and position information about the object displayed on the high-precision map, may be calculated based on a grid searching algorithm that sequentially calculates position scores of all the grids included in the grid map according to a set criterion, or may be calculated based on a random searching algorithm that calculates position scores only for random grids included in the grid map.

Since the positioning device 100 according to the disclosure is intended to measure the accurate position of the vehicle, it is proposed to calculate the position score based on the grid searching algorithm that sequentially calculates position scores of all the grids.

The positioning device 100 for measuring the position of the vehicle may include a position determiner 130 for searching for the second grid having the highest position score and correcting the position value of the vehicle based on the position convergence determination result of the second grid. The positioning device 100 according to the disclosure may select a grid having the highest position score among all the grids included in the grid map by viewing the grid as a place where the vehicle is highly likely to be positioned, and determine the final position of the vehicle by determining whether the position converges to the second grid by setting a specific criterion.

For example, the position determiner 130 may determine whether

the position converges by comparing the position score of the second grid with a threshold, and may determine that the position converges when the position score of the second grid is larger than or equal to the threshold. The threshold is not a fixed value, but may be set as various as needed.

As another example, the position determiner 130 may determine whether the position converges based on the position score for each grid calculated for each round, and may determine that the position converges when the round having the highest position score of the second grid is the most. The positioning device 100 according to the disclosure may perform the calculation of the position score for each grid two or more times, rather than only once, according to a set criterion, select the grid having the highest position score for each round, and determine that the most performed grid selected as the grid having the highest position score is the second grid where the position converges.

As another example, the position determiner 130 may determine whether the position converges based on the average of the position scores for each grid calculated for each round, and determine the position converges when the average of the position scores of the second grid is the highest. The positioning device 100 according to the disclosure may calculate the position score two or more times according to a set criterion, and determine the grid having the highest position score average calculated, as the second grid where the position converges.

As another example, the position determiner 130 may determine whether the position converges based on the number of times in which it is selected as the grid having the highest position score, and when the second grid is a grid selected consecutively N times (where N is an integer of 1 or more), the position determiner 130 may determine that the position converges. The positioning device 100 according to the disclosure may determine the grid selected N times or more consecutively as the grid having the highest position score as the second grid where the position converges.

As another example, the position determiner 130 may correct the GPS position information about the vehicle based on the position of the second grid, based on the position convergence determination result of the second grid being the position convergence. If the GPS position information is corrected to the position where the vehicle is most likely to be positioned, the position determiner 130 may transmit a signal including the corrected vehicle GPS position information to the GPS satellite that transmitted the GPS position information, another GPS satellite, a terminal, or a ground station.

The positioning device 100 according to the disclosure may correct the GPS position information about a vehicle through a GPS position-based position logic when the vehicle GPS position information received from a GPS satellite is unreliable like when multipath is caused for the GPS signals by high-rise buildings on a road in an urban area, and may thus enhance the reliability of GPS position information and obtain high-quality positioning information. Therefore, it is possible to reduce the occurrence rate of traffic accidents by increasing the position precision of vehicles in areas with heavy traffic, high-rise buildings, or traffic accidents.

Further, by accurately measuring the position of a vehicle driving in an urban area with complicated roads, it is possible to prevent the vehicle from reaching the destination late due to incorrect judgement of the driving route to the destination.

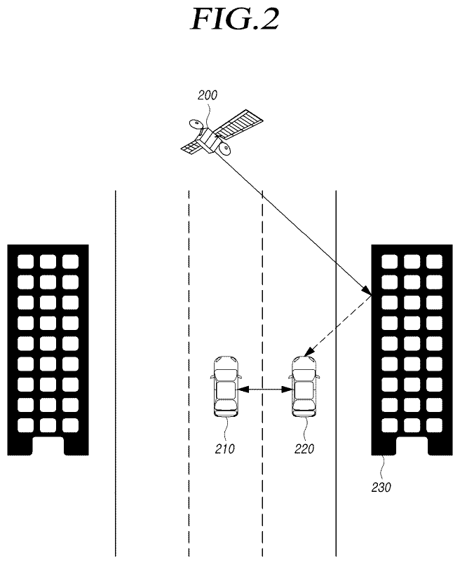

Hereinafter, a process of measuring an accurate position of a vehicle based on GPS position information is described in detail with reference to FIG. 2 and the subsequent figures.

FIG. 2 is a view illustrating a problem of a related art in which GPS position information about a vehicle received from a GPS satellite is unreliable.

As described above, the GPS satellite 200 may measure the position of the vehicle based on the arrival time of the signal transmitted toward the vehicle. However, an error may occur between the vehicle position information measured based on the signal transmitted by the GPS satellite 200 and the actual position of the vehicle. This error may be caused by multipath in which the satellite signal transmitted from the GPS satellite 200 is refracted while passing through the Earth's atmosphere, the satellite itself transmits incorrect GPS position information, or the satellite signal is reflected through a high-rise building 230 positioned on the ground.

For example, referring to FIG. 2, the satellite signal transmitted from the GPS satellite 200 may pass through gas or liquid well, but does not pass through a solid but is reflected. In order to measure the position of the vehicle 210, the satellite signal transmitted from the GPS satellite 200 may be reflected by the building 230, so that the vehicle may be determined to be positioned in a lane 220 different from the lane 210 in which the actual vehicle is positioned.

As a result, the vehicle may be controlled to change the lane by receiving wrong position information or, although it should be controlled to decelerate due to the presence of a stopped preceding vehicle, the vehicle may be controlled to accelerate by misjudging that there is no preceding vehicle, causing an unexpected accident. Further, as the moving route to the destination is incorrectly determined, it may take a long time for the vehicle to reach the destination.

In this regard, the disclosure proposes a method for configuring a grid map reflecting GPS position information about a vehicle and information about objects around the vehicle to correct vehicle GPS position information that is unreliable due to reasons such as multipath, calculating a position score for a position possibility of the vehicle for each grid included in the grid map, and correcting the GPS position information according to a set criterion.

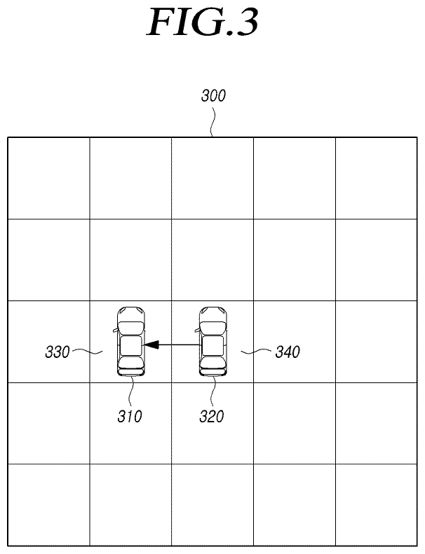

FIG. 3 is a view illustrating a method for measuring the position of a vehicle, by a positioning device, based on a position score of a grid, according to an embodiment.

A positioning device according to the disclosure may determine whether GPS position information about a vehicle received from a GPS satellite is accurate, and correct vehicle GPS position information received from the GPS satellite when it is determined that the GPS position information is not accurate.

Referring to FIG. 3, the positioning device according to the disclosure generates a grid map 300 including a grid 340 reflecting vehicle GPS position information 320 received from a GPS satellite. The central grid 340 of the grid map 300 may reflect the vehicle position information 320 received from the GPS satellite. Further, the number of grids included in the grid map 300 is not limited to 25 as illustrated in FIG. 3, and may be 9 or 49 or more as necessary. Further, the shape of the grid is not limited to a square, and may be set to various shapes as needed, and the size of each grid may be set to various sizes as needed.

The grid map 300 may reflect the vehicle GPS position information 340 obtained from the GPS satellite, and may also reflect information about objects around the vehicle detected by the sensing means provided in the vehicle or position information about objects displayed on a high-precision map.

The positioning device according to the disclosure may calculate the position score of each grid included in the grid map. The position score of the grid may be calculated based on information about the object around the vehicle detected by a sensing means provided in the vehicle or position information about the object displayed on the high-precision map.

As the method for calculating the position score of the grid, a grid searching scheme for sequentially calculating the position scores of all the grids included in the grid map and a random searching scheme for calculating the position score only for a random grid may be used. The grid searching scheme has the advantage of being able to determine the position of the vehicle for all the grids included in the grid map, and the random searching scheme has the advantage of being able to quickly search for the candidate grid where the vehicle is positioned. However, the random searching scheme has a disadvantage in that the accuracy of identifying the position of the vehicle may be reduced in that the calculation of the position score for the grid where the actual vehicle is positioned may be omitted. Therefore, the disclosure proposes a random searching scheme for sequentially calculating position scores of all the grids in that the disclosure aims to derive an accurate position of a vehicle.

For example, the positioning device may search for a grid having the highest probability of being the position of the vehicle by repeatedly calculating the position score for each surrounding grid from the grid reflecting the GPS position information.

However, the position score calculation method is not limited thereto, and various schemes may be used as necessary.

Further, calculation of the position score for each grid may be repeated several times as necessary, without being limited to being performed once.

If the position score for each grid is calculated, the positioning device selects the grid having the highest position score and determines whether the position converges for the selected grid.

When it is identified that a grid 330 other than the grid 340 reflecting the GPS position information is the actual position 310 of the vehicle according to the result of determining whether the position converges, the positioning device corrects the GPS position information to the position of the grid 330 identified as the actual position 310 of the vehicle.

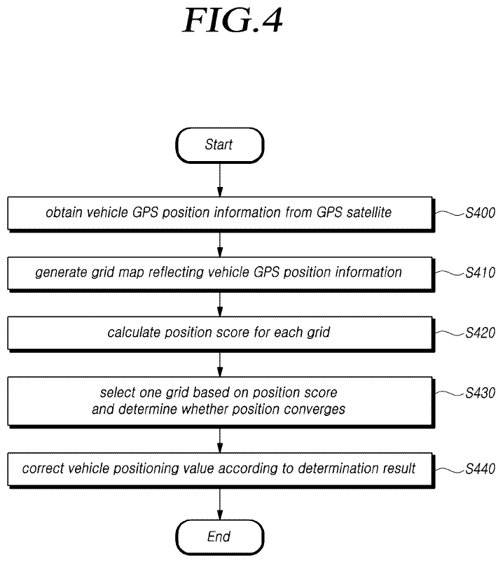

FIG. 4 is a flowchart illustrating a process of measuring the position of a vehicle, by a positioning device, based on a position score of a grid, according to an embodiment.

The positioning device according to the disclosure obtains vehicle GPS position information from a GPS satellite (S400), generates a grid map reflecting the vehicle GPS position information (S410), calculates a position score for each grid included in the grid map (S420), selects a grid having the highest calculated position score, determines whether the position converges for he selected grid (S430), and corrects the positioning value of the vehicle according to the position convergence determination result (S440).

Specifically, the positioning device according to the disclosure obtains vehicle GPS position information from the GPS satellite (S400). The positioning device may further obtain not only vehicle GPS position information, but also sensing information detected by a sensing means provided in the vehicle and information displayed on the high-precision map. The sensing information and the information displayed on the high-precision map may include information about dynamic objects and static objects around the vehicle other than the vehicle reflecting the GPS position information. The additionally obtained information may be used to calculate the position score of the grid.

If the vehicle GPS position information is obtained, the positioning device generates a grid map reflecting the vehicle GPS position information (S410). The grid map may include at least one grid. The grid map may be configured in a form in which the grid reflecting vehicle GPS position information is used as a central grid, and the remaining grids surround the central grid. The shape and total number of grid maps are not limited but may be set as various as necessary.

If the grid map is generated, the positioning device calculates the position score for each grid (S420). As described above, the position score may be calculated based on a grid searching scheme that sequentially calculates the position score of each grid.

If the position score for each grid is calculated, the positioning device may select one grid having the highest position score and determine whether the position converges for the selected grid (S430).

A high position score means that the vehicle is highly likely to be positioned in the grid. However, whether the selected grid matches the grid where the vehicle is actually positioned may vary depending on a result of determining whether the position converges for the selected grid. The positioning device may determine whether the position converges for the selected grid according to a set criterion.

For example, the positioning device according to the disclosure may determine that the position of the selected grid converges only when the position score of the selected grid is larger than or equal to a set threshold. For example, when the grid for which a position score of 50 points is calculated is the grid having the highest position score, if the set threshold is 40 points, the positioning device according to the disclosure may determine that the position of the grid converges. However, when the set threshold is 60 points, the positioning device according to the disclosure may determine that the position of the grid does not converge.

As another example, the positioning device may calculate the position score of each grid two or more times to select the grid for which the highest position score is calculated for each round, and determine that the position converges for the most selected grid.

As another example, the positioning device may calculate the position score of each grid two or more times, calculate an average position score for each grid, and determine that the position converges for the grid having the highest average score.

As another example, the positioning device may calculate the position score of each grid two or more times and, when the number of times in which the grid having the highest position score is selected as the grid having the highest position score is N or more (where N is an integer of 1 or more), determine that the position converges for the grid.

The method for determining whether the position converges for the grid is not limited to the above-described method, and various methods may be used as necessary to measure the position of the vehicle.

If the determination regarding the position convergence of the grid is performed, the positioning device may correct the position value of the vehicle or perform the above-described process again according to the determination result (S440).

For example, when it is determined that the position converges for the selected grid, the positioning device may correct the obtained GPS position information to the position information about the selected grid. The corrected vehicle GPS position information may be transmitted to the GPS satellite that transmitted the GPS position information, another GPS satellite, or a separate ground terminal or ground station that communicates with the GPS satellite.

As another example, when it is determined that the position does not converge for the selected grid, the positioning device may regenerate the grid map reflecting the selected grid. The selected grid may be set as a central grid of the regenerated grid map. If the grid map is regenerated, the positioning device may calculate the position score of the grid included in the regenerated grid map, select the grid having the highest position score, and determine whether the position converges for the selected grid. If the position does not converge for the selected grid, the above-described process may be repeatedly performed until the converged result is obtained. Alternatively, if the position does not converge even after being repeatedly performed a set number of times, the last selected grid may be finally determined as the position of the vehicle.

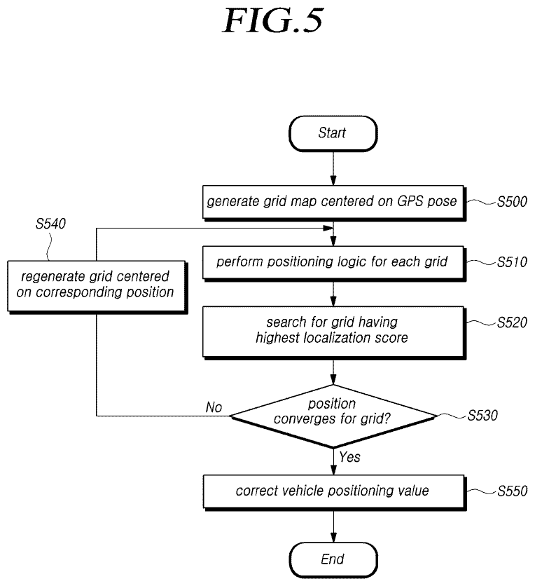

FIG. 5 is a flowchart illustrating a process of measuring the position of a vehicle, by a positioning device, according to an embodiment.

Referring to FIG. 5, the position score of the grid may be calculated through the positioning device according to the disclosure, and the GPS satellite information may be corrected based on the calculation result.

The above-described positioning device may generate a grid map based on vehicle GPS position information obtained from the GPS satellite (S500). The positioning device may reflect GPS position information and sensing information about the vehicle and information about objects around the vehicle obtained through the high-precision map to the grid included in the grid map. The objects around the vehicle may include both static objects and dynamic objects.

If the grid map is generated, the positioning device may perform positioning logic for each grid (S510). The disclosure proposes a grid searching scheme as positioning logic performed for each grid. By calculating and comparing the position scores of all the grids included in the grid map, the position at which the vehicle is most likely to be positioned may be derived. In the disclosure, the calculated position score for each grid may be referred to as a localization score.

If the position score for each grid is identified, the positioning device searches for the grid having the highest position score (S520). A high position score means that the vehicle is most likely to be positioned in the grid.

When the grid having the highest position score is searched, the positioning device determines whether the position converges for the searched grid (S530). The determination as to whether the position converges may be performed according to the method of comparing the position score and the threshold, the method of considering the number of times of being selected as the grid having the highest position score as calculated for each round, the method of considering the average position score calculated for each round, and the method of considering how many times the grid has been selected as the grid having the highest position score, as described above.

If it is determined that the position does not converges for the searched grid, the positioning device regenerates the grid map centered on the searched grid, performs positioning logic for each grid of the regenerated grid map, re-searches for the grid having the highest position score, and determines whether the position converges for the re-searched grid converges again (S540).

If it is determined that the position converges for the searched grid, the positioning device corrects the GPS position information by reflecting the position information about the searched grid (S550). The corrected vehicle GPS position information may be transmitted to the GPS satellite that transmitted the GPS position information, another GPS satellite, or a separate ground terminal or ground station that communicates with the GPS satellite.

Each of the above-described steps is an example, and the disclosure is not limited thereto, and some steps may be omitted or the order of performance may be changed.

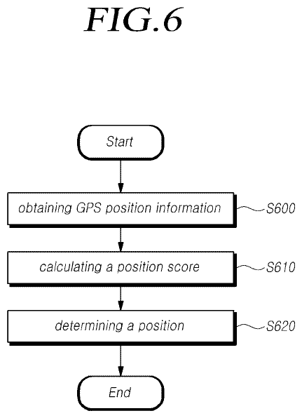

FIG. 6 is a view illustrating a positioning method for correcting a positioning value of a vehicle, by a positioning device, according to an embodiment.

Referring to FIG. 6, the positioning method for measuring the position of the vehicle may include obtaining vehicle GPS position information from a GPS satellite (S600).

For example, obtaining GPS position information may further obtain high-precision map information including position information about an object around the vehicle and sensing information.

An object according to the disclosure is to correct position information about a vehicle, assuming that the position information about the vehicle received from the GPS satellite may be inaccurate. The correction of the vehicle position information may be performed based on the sensing information sensed by the sensing means provided in the vehicle and the position information about the object displayed on the high-precision map. The object may include a static object and a moving dynamic object.

The positioning method according to the disclosure may measure the position that is most likely to be the position of the vehicle through sensing information, position information about the object obtained from the high-precision map, and the grid searching scheme.

The method for measuring the position of the vehicle may include calculating a position score for generating a grid map including a first grid reflecting GPS position information, and calculating a position score associated with a possibility that the vehicle is positioned for each grid of the grid map based on the sensing information (S610).

The grid map is a virtual map including one or more grids, and may have various shapes, such as a square, a rectangle, a triangle, and a circle, if necessary.

For example, calculating the position score may generate the grid map, centered on the first grid. The first grid may be a grid reflecting the position information received from the GPS satellite, and the grid map according to the disclosure may have a form in which other grids surround the first grid. The number of layers of the grid surrounding the first grid may be one layer. However, the disclosure is not limited thereto, and it may be a grid map composed of more layers as necessary.

As another example, calculating the position score may regenerate a grid map, centered on the second grid and recalculate the position score for each grid included in the grid map, based on the position convergence determination result of the second grid not being position convergence. The second grid refers to the grid having the highest network score among all of the grids included in the grid map centered on the first grid.

The positioning method may determine whether the second grid may be finally determined as the position of the vehicle according to a set criterion. In the disclosure, this may be referred to as position convergence determination. If it is determined that the second grid does not converge to the position of the vehicle according to the positioning method, calculating the position score included in the positioning method may regenerate the grid map centered on the second grid and recalculate the position score of each grid included in the grid map. Regeneration of the grid map and recalculation of the position score of each grid are not limited to being performed one time, and if it is determined that the position convergence determination result is not position convergence, they may be repeatedly performed two or more times.

As another example, calculating the position score may calculate the position score for each grid based on a grid searching algorithm that sequentially calculates the position score for each grid included in the grid map. The position score for each grid may be calculated based on sensing information and position information about the object displayed on the high-precision map, may be calculated based on a grid searching algorithm that sequentially calculates position scores of all the grids included in the grid map according to a set criterion, or may be calculated based on a random searching algorithm that calculates position scores only for random grids included in the grid map.

Since the positioning method according to the disclosure is intended to measure the accurate position of the vehicle, it is proposed to calculate the position score based on the grid searching algorithm that sequentially calculates position scores of all the grids.

The positioning method for measuring the position of the vehicle may include determining a position for searching for the second grid having the highest position score and correcting the positioning value of the vehicle based on the position convergence determination result of the second grid (S620). The positioning method according to the disclosure may determine that the grid having the highest position score among all the grids included in the grid map is the position of the vehicle, and determine the final position of the vehicle by determining whether the position converges to the second grid by setting a specific criterion.

For example, determining the position may determine whether the position converges by comparing the position score of the second grid with a threshold, and may determine that the position converges when the position score of the second grid is larger than or equal to the threshold. The threshold is not a fixed value, but may be set as various as needed.

As another example, determining the position may determine whether the position converges based on the position score for each grid calculated for each round, and may determine that the position converges when the round having the highest position score of the second grid is the most. The positioning method according to the disclosure may perform the calculation of the position score for each grid two or more times, rather than only once, according to a set criterion, select the grid having the highest position score for each round, and determine that the most performed grid selected as the grid having the highest position score is the second grid where the position converges.

As another example, determining the position may determine whether the position converges based on the average of the position scores for each grid calculated for each round, and determine the position converges when the average of the position scores of the second grid is the highest. The positioning method according to the disclosure may calculate the position score two or more times according to a set criterion, and determine the grid having the highest position score average calculated, as the second grid where the position converges.

As another example, determining the position may determine whether the position converges based on the number of times in which it is selected as the grid having the highest position score, and when the second grid is a grid selected consecutively N times (where N is an integer of 1 or more), the position determiner 130 may determine that the position converges. The positioning method according to the disclosure may determine the grid selected N times or more consecutively as the grid having the highest position score as the second grid where the position converges.

As another example, determining the position may correct the GPS position information about the vehicle based on the position of the second grid, based on the position convergence determination result of the second grid being the position convergence. If the GPS position information is corrected to the position where the vehicle is most likely to be positioned, determining the position may transmit a signal including the corrected vehicle GPS position information to the GPS satellite that transmitted the GPS position information, another GPS satellite, a terminal, or a ground station.

Through the operations of the above-described steps, it is possible to determine whether GPS position information is accurate and control the vehicle according to accurate position information, thereby preventing an unexpected vehicle accident that may occur due to control based on inaccurate information.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed:

1. A positioning device, comprising:
an information obtainer obtaining global positioning system (GPS) position information about a vehicle from a GPS satellite;
a position score calculator generating a grid map including a first grid reflecting the GPS position information, and calculating a position score associated with a possibility that the vehicle is to be positioned for each grid of the grid map based on sensing information; and
a position determiner searching for a second grid having a highest position score and correcting a positioning value of the vehicle based on a position convergence determination result of the second grid.

2. The positioning device of claim 1, wherein the information obtainer further obtains high-precision map information including position information about an object around the vehicle and the sensing information.

3. The positioning device of claim 1, wherein the position score calculator generates the grid map, centered on the first grid.

4. The positioning device of claim 3, wherein the position score calculator regenerates the grid map, centered on the second grid, and recalculates the position score for each grid included in the grid map, based on the position convergence determination result of the second grid not being position convergence.

5. The positioning device of claim 1, wherein the position score calculator calculates the position score for each grid based on a grid searching algorithm that sequentially calculates the position score for each grid included in the grid map.

6. The positioning device of claim 1, wherein the position determiner determines whether a position converges by comparing a position score of the second grid with a threshold and, when the position score of the second grid is the threshold or more, determines that the position converges.

7. The positioning device of claim 1, wherein the position determiner determines whether a position converges based on the position score for each grid calculated for each round and, when a round having a highest position score of the second grid is most, determines that the position converges.

8. The positioning device of claim 1, wherein the position determiner determines whether a position converges based on an average position score for each grid calculated for each round and, when the average position score of the second grid is highest, determines that the position converges.

9. The positioning device of claim 1, wherein the position determiner determines whether a position converges based on a number of times of being selected as a grid having a highest position score and, when the second grid is a grid consecutively selected N times (wherein N is an integer of 1 or more), determines that the position converges.

10. The positioning device of claim 1, wherein the position determiner corrects the GPS position information about the vehicle based on a position of the second grid, based on the position convergence determination result of the second grid being position convergence.

11. A positioning method, comprising:
obtaining global positioning system (GPS) position information about a vehicle from a GPS satellite;
calculating a position score for generating a grid map including a first grid reflecting the GPS position information, and calculating the position score associated with a possibility that the vehicle is to be positioned for each grid of the grid map based on sensing information; and
determining a position for searching for a second grid having a highest position score and correcting a positioning value of the vehicle based on a position convergence determination result of the second grid.

12. The positioning method of claim 11, wherein obtaining GPS position information further obtains high-precision map information including position information about an object around the vehicle and the sensing information.

13. The positioning method of claim 11, wherein calculating the position score generates the grid map, centered on the first grid.

14. The positioning method of claim 13, wherein calculating the position score regenerates the grid map, centered on the second grid, and recalculates the position score for each grid included in the grid map, based on the position convergence determination result of the second grid not being position convergence.

15. The positioning method of claim 11, wherein calculating the position score calculates the position score for each grid based on a grid searching algorithm that sequentially calculates the position score for each grid included in the grid map.

16. The positioning method of claim 11, wherein determining the position determines whether a position converges by comparing a position score of the second grid with a threshold and, when the position score of the second grid is the threshold or more, determines that the position converges.

17. The positioning method of claim 11, wherein determining the position determines whether a position converges based on the position score of the second grid calculated for each round and, when a round having a highest position score of the second grid is most, determines that the position converges.

18. The positioning method of claim 11, wherein determining the position determines whether a position converges based on an average position score of the second grid calculated for each round and, when the average position score of the second grid is highest, determines that the position converges.

19. The positioning method of claim 11, wherein determining the position determines whether a position converges based on a number of times of being selected as a grid having a highest position score and, when the second grid is a grid consecutively selected N times (wherein N is an integer of 1 or more), determines that the position converges.

20. The positioning method of claim 11, wherein determining the position corrects the GPS position information about the vehicle based on a position of the second grid, based on the position convergence determination result of the second grid being position convergence.
